(19) United States
(12) Patent Application Publication
(10) Pub. No.: US 2004/0147192 A1
(43) Pub. Date: Jul. 29, 2004

(54) Carbon fiber friction material

(75) Inventors: Donald F. Connors JR., Hudson, NH (US); David Giannelli, Burlington, MA (US); Robert W. Pepper, Raymond, NH (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Material Products Inc., Lowell, MA (US)

(21) Appl. No.: 10/351,457

(22) Filed: Jan. 24, 2003

(51) Int. Cl. B29C 31/00; B32B 27/38; B29C 51/00; B32B 5/02; B29D 29/00; B29D 29/08; B29D 24/00; D03D 25/00; D03D 15/00; B29D 29/06; B29C 43/02; B29C 49/00

(52) U.S. Cl. 442/175; 442/179; 264/546; 264/101

(57) ABSTRACT

A carbon friction material, preferably a woven carbon friction material, wherein a binder such as an epoxy or phenolic resin is used to strengthen and impart rigidity to the friction material. The friction material has a graded concentration of the binder such that the friction surface may have substantially no binder. A reinforcing substrate such as a fiberglass backing may also be present. The coefficient of friction at the friction surface may be further increased by, for example, shaving the surface such that a plurality of fibers become oriented in a direction perpendicular to the friction surface.

### BACKGROUND OF THE INVENTION

1. Field of the Invention

The invention relates to carbon fiber friction materials. More particularly, the invention relates to wet friction applications as used, for example, in automotive continuous slip service such as that in torque converter clutches.

2. Description of the Related Art

In wet friction applications, at least two cooperating members are adapted to be moved into and out of frictional engagement with mutually opposing surfaces. At least one of the cooperating members comprises a friction material. As it is a wet friction application, an oil or other suitable cooling medium is circulated about and between the friction material and the opposing surface.

Typically, carbon friction materials have been produced by coating pyrolitic carbon by a chemical vapor deposition (CVD) process on the fibers of a cloth substrate. The CVD process densifies the cloth substrate thereby imparting strength to the material. However, pyrolitic-carbon fabric typically impedes the flow of the cooling fluid.

An alternative approach disclosed in U.S. Pat. No. 5,662,993 involves dipping a carbon-based cloth substrate into a phenolic resin solution. Excess resin solution is drained away such that the resin is entirely contained within the strands in the carbon cloth with the strands intentionally incompletely filled. The material is then cured to provide the carbon friction material.

Desirable characteristics of a friction material include low cost, high wear resistance, high heat resistance, high coefficients of friction, consistent coefficients of friction over time, as well as over a wide heat and load range. Minimal differences in static and dynamic coefficients of friction may also be beneficial by leading to reduced vibration in wet friction applications. While previous materials may possess some or all of these characteristics to some degree, there continues to be a need for improved carbon friction materials.

### BRIEF SUMMARY OF THE INVENTION

A carbon fiber friction material comprises a carbon fiber substrate with a graded binder concentration such that the amount of binder decreases across the thickness of the substrate from the base surface to the friction surface. This may lead to the friction surface being substantially free of binder. The binder may be a resin such as, for example, an epoxy or phenolic resin and the carbon substrate may be a woven or non-woven carbon fabric. In an embodiment, the fabric is bonded to a reinforcing substrate, such as, for example a fiberglass fabric.

In a further embodiment, the coefficient of friction of the friction surface is increased by having a plurality of fibers at the friction surface oriented in a direction substantially perpendicular to the friction surface.

In another embodiment, the method of manufacturing a carbon fiber friction material comprises:

(a) providing a carbon substrate;

(b) providing a binder containing layer; and

(c) laminating the carbon substrate and the binder containing layer together such that the binder infiltrates the carbon substrate.

The binder-containing layer may be a reinforcing fabric such as, for example, a fiberglass fabric. In such a case, the providing a binder-containing layer comprises casting a binder into the reinforcing fabric. After the lamination step, a carbon friction material would be provided with the reinforcing fabric as carrier. Alternatively, the binder may be cast on a release liner to provide a carbon friction material without such a carrier layer.

The laminating step may be completed by, for example, heating under a vacuum. In another embodiment, the laminating step may be completed by heating under pressure. In such embodiments, the heating may be, for example, from about 120 to about 175° C.

In yet another embodiment, the method further comprises increasing the coefficient of friction of the friction surface. This increasing step may be accomplished by, for example, shaving at least 50 cm such as between 50 μm and 200 μtm, more particularly such as between 70 μm and 125 μm from the friction surface.

### BRIEF DESCRIPTION OF THE SEVERAL VIEWS OF THE DRAWINGS

FIG. 1 graphically illustrates a method to make a carbon friction material.

FIG. 2 is a scanning electron microscope image of a carbon friction material.

FIG. 3 is a scanning electron microscope image of a carbon friction material.

### DETAILED DESCRIPTION OF THE INVENTION

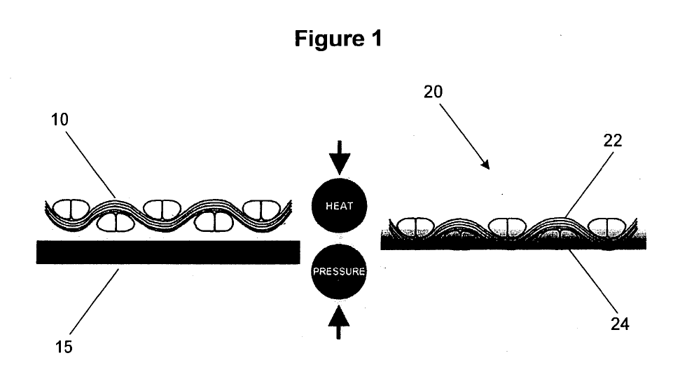

FIG. 1 illustrates an embodiment of the present invention whereby a carbon fiber substrate 10 and a binder-containing layer 15 are laminated together through the application of heat and pressure to produce a carbon friction material 20. The binder infiltrates the carbon substrate in a graded manner such that there is a higher concentration of binder at a base surface 24 as compared to a friction surface 22. Furthermore, there may even be little or no binder at friction surface 22.

Carbon fiber substrate 10 may be woven or non-woven carbon fabric. Woven fabrics are those fabrics comprised of fibers arranged in substantially regular patterns or alignment, such as by weaving, knitting or braiding. A woven fabric can be prepared by using a weaving machine, for example, a fly weaving machine or a rapier loom, or a knitting machine, such as a circular or flatbed knitting machine. Woven fabrics include woven materials in which some of the fibers have been disordered by, for example needle punching or hydroentangling. More complex structures may also be manufactured by weaving or knitting multilayers of yarns together. These multilayered fabrics may then be mechanically separated using slitting and shearing equipment to form fabrics with fiber ends parallel to the “z” direction (a direction perpendicular to the friction surface) and are commonly referred to as having a plush, suede or corduroy finish.

Non-woven substrates include felts, webs, batts, and mats such as a staple fiber web, for example a carded web, or a non-woven produced by other web forming techniques, for example by air laying, wet laying, or by aerodynamic or hydrodynamic web formation. Techniques such as needle punching or hydroentangling may be employed to increase the entanglement of the fibers in a non-woven substrate. A non-woven substrate, when viewed under magnification, is generally made up of a number of individual, discernable fibers that are randomly entangled to give the web a certain degree of integrity. The degree of integrity is due, at least in part, to the fiber composition, tenacity, fiber length, density and degree of fiber entanglement. The integrity of the web can be further enhanced through interfilament bonding, which can be achieved through the use of heat, pressure, adhesives or a combination of the foregoing.

The carbon fiber can also be spun or co-mingled with other fibers such as “glass”, silicon carbide, soft/hard ceramics, aramid, boron, polytetrafluoroethylene, or other fibers or coated fibers.

Binder impregnated within the carbon substrate is used to strengthen and impart rigidity thereto. The binder may be a resin, for example an epoxy or phenolic resin. In particular, a graded binder concentration can be used to impart favorable physical characteristics on the friction material. For example, a graded binder concentration allows for a compliant friction surface while maintaining a higher binder content at the base surface. It is thus unnecessary to maintain a uniform binder concentration across the thickness of the carbon substrate in order to maintain frictional characteristics.

Binder containing layer 15 may be, for example, a reinforcing fabric backing layer containing a binder. Due to the lamination process, binder from the reinforcing fabric infiltrates the carbon substrate in a graded manner. The surface of the friction material next to the reinforcing fabric is thus base surface 24 and the amount of binder at the base surface is comparatively high and decreases through the thickness of the carbon fiber. The reinforcing fabric backing provides added structural integrity and may be, for example, a fiberglass fabric coated with resin. In an alternate embodiment, binder-containing layer 15 may be, for example, a cast resin film on a release liner. In such an embodiment, the friction material is manufactured without a reinforcing backing.

The lamination step may be performed with conventional techniques as known to a person skilled in the art. For example, binder containing layer 15 and carbon substrate 10 may be heated to a temperature from about 120° C. to about 175° C. under a vacuum until cured, which is typically about 30 minutes. Once cured, the laminates may then be removed from the vacuum to yield the friction material. Alternatively, hot pressing to a temperature from about 120° C. to about 175° C. under a pressure of 15 to 100 psi until cured may similarly yield friction material 20. More particularly, the pressure used in the lamination step may be 30 to 50 psi. Continuous process equipment may be used wherein feed speed, applied pressure and temperature can be easily controlled. This type of equipment is well known in the art and would likely be an efficient manufacturing process for high volumes.

The lamination process, as described above, would likely cause the resin concentration to continually decrease across the thickness of the carbon substrate in friction material 20. Nevertheless, it is understood that embodiments in which the resin content decreases in steps or otherwise discontinuously is also within the scope of the present invention.

Carbon substrate 10 may be formed of multiple layers though improved characteristics of friction material 20 tend to be observed when only a single layer material is used for carbon substrate 10. A carbon substrate is available from Ballard Material Products, Lowell, Mass. as AVCARB™ carbon fabrics, woven from oxidized polyacrylonitrile fiber yarns. Similarly, the fiberglass fabric may be formed of multiple layers of fiberglass prepeg. The fiberglass may be an “E” glass, style 7781 with an epoxy or phenolic resin which is available from FiberCote Industries, Inc, Waterbury, Conn. A suitable phenolic resin is available from Ashland Chemical Co., Columbus, Ohio.

A surface treatment of the friction material may be undertaken to increase the coefficient of friction and thereby further improve the frictional properties of the material. The surface treatment may, for example, involve shaving at least 50 μm of material from the surface. For example, between 50 μm and 200 μm, more particularly between 75 μm and 125 μm of material should be removed in such a surface treatment.

By shaving the surface, the fibers are no longer confined within the yarns that make up the carbon substrate. Instead, a plurality of fibers become oriented in the z direction perpendicular to the friction surface thereby increasing the coefficient of friction.

The shaving step may be performed, for example, with a surface grinding apparatus with a diamond faced grinding wheel. An alternate technique for machining would be to use a microgrinder as supplied by Curtin-Hebert Co., Inc. Gloversville, N.Y.

### EXAMPLE

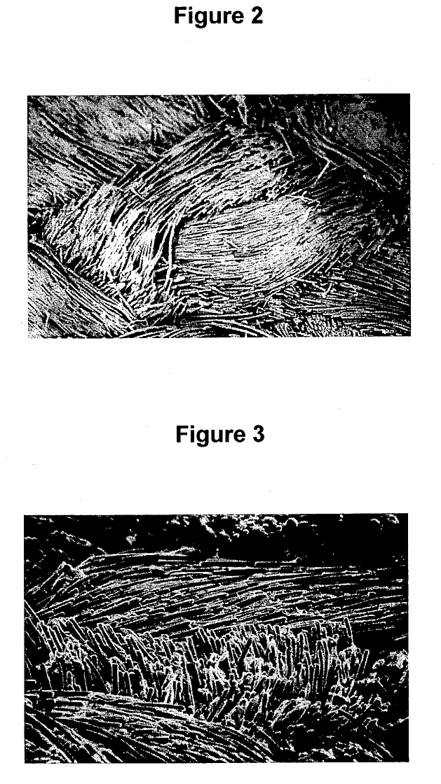

Onto an aluminum caul plate was placed three plies of 7781 fiberglass woven cloth impregnated with an epoxy resin (Fibercote Industries of Connecticut), and then one ply of a carbon woven cloth CPW-006 (Ballard Material Products of Massachusetts). A vacuum bagging material was then used to cover plys of fabric and sealed to the caul plate using a vacuum sealing tape. A valve was then inserted in the vacuum bag to allow for a vacuum to be applied during the curing process. The caul plate was then placed in an oven and a vacuum was applied to the assembly of 28″ to 30″ of Hg (710-760 mm Hg). After the vacuum was established, the assembly was heated to a temperature of 180 F. (80° C.) at a rate of 3 to 5 degrees per minute (2-3° C./min). After 30 minutes, the assembly was then heated to 325 F. (160° C.) at the same rate. After an additional 30 minutes at 325 F., the assembly was allowed to cool to room temperature overnight under vacuum. The composite material was then removed from the caul plate. One face of the composite was then treated using a Clausing Jakobsen Grinder model 618 with a 320 grit resin bonded diamond wheel supplied by Notron Company, operated at 3400 rpm with a feed rate of 5 inches per minute (13 cm/min). 0.003″ (75 μm) of material was then removed from the top surface of the composite at a rate of 0.0001″ (2.5 μm) per pass to yield the friction material shown in FIGS. 2 and 3.

Woven fabrics such as the plain weave designs the plain weave designs shown in FIGS. 2 and 3 exhibit good conformability of the individual fibers within yarn bundles in both the warp and fill directions. The small length to diameter ratio fibers offers a high contact stiffness and fiber density volume.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method of manufacturing a carbon friction material comprising:
providing a carbon substrate;
providing a binder containing layer; and
laminating the carbon substrate and the binder containing layer together such that the binder infiltrates the carbon fabric.

2. The method of claim 1 wherein the carbon substrate is a woven fabric.

3. The method of claim 1 wherein the carbon substrate is a non-woven fabric.

4. The method of claim 1 wherein the binder is a resin.

5. The method of claim 4 wherein the resin is an epoxy or phenolic resin.

6. The method of claim 1 wherein the providing a binder containing layer step comprises casting the binder into a reinforcing substrate.

7. The method of claim 6 wherein the reinforcing substrate is a fiberglass fabric.

8. The method of claim 1 wherein the providing a binder containing layer step comprises casting a binder film on a release liner.

9. The method of claim 1 wherein the laminating step comprises heating the carbon substrate and the binder containing layer under a vacuum.

10. The method of claim 9 wherein the heating step is to a temperature from 120-175° C.

11. The method of claim 1 wherein the laminating step comprises applying heat and pressure to the carbon substrate and the binder containing layer.

12. The method of claim 11 wherein the applying heat step is to a temperature from 120-175° C.

13. The method of claim 11 wherein the pressure is from 15 psi to 100 psi.

14. The method of claim 11 wherein the pressure is from 30 psi to 50 psi.

15. The method of claim 1 wherein the carbon substrate has a friction surface and a base surface, the base surface being laminated to the binder containing layer, the method further comprising increasing the coefficient of friction at the friction surface.

16. The method of claim 14 wherein the increasing the coefficient of friction step comprises shaving the friction surface.

17. The method of claim 15 wherein the shaving step removes at least 50 μm from the friction surface.

18. The method of claim 16 wherein the shaving step removes from 50 μm to 200 μm from the friction surface.

19. The method of claim 16 wherein the shaving step removes from 75 μm to 125 μm from the friction surface.

20. A friction material comprising:
a carbon substrate having a friction surface and a base surface;
a binder infiltrated within the carbon substrate wherein the amount of binder decreases from the base surface to the friction surface.

21. The friction material of claim 20 wherein the friction surface is substantially free of binder.

22. The friction material of claim 20 wherein the carbon substrate is a woven fabric.

23. The friction material of claim 20 wherein the carbon substrate is a non-woven fabric.

24. The friction material of claim 20 wherein the binder is a resin.

25. The friction material of claim 20 wherein the resin is an epoxy or phenolic resin.

26. The friction material of claim 20 further comprising a reinforcing substrate bonded to the base surface.

27. The friction material of claim 26 wherein the reinforcing substrate is a fiberglass fabric.

28. The friction material of claim 20 wherein the carbon fabric comprises a plurality of fibers at the friction surface oriented in a direction substantially perpendicular to the friction surface.
